(19) United States
(12) Patent Application Publication
(10) Pub. No.: US 2005/0140402 A1
(43) Pub. Date: Jun. 30, 2005

(54) Frequency converter

(76) Inventors: Jin Bong Sung, Daejeon-city (KR); Sung Weon Kang, Daejeon-city (KR); Jung Hwan Hwang, Daejeon-city (KR); Chang Hee Hyoung, Daejeon-city (KR); Yun Tae Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/866,458

(22) Filed: Jun. 10, 2004

(30) Foreign Application Priority Data
Dec. 24, 2003 (KR) 2003-96891

(51) Int. Cl. H04B 1/40

(52) U.S. Cl. 327/113

(57) ABSTRACT

Provided is a frequency converter that can remove a DC offset and suppress spurious response and intermodulation. The frequency converter receives a reference signal and a local oscillator signal and outputs a frequency component corresponding to the sum or difference of the reference signal and the even-order harmonics of local oscillator signal. The frequency converter includes a reference signal input part including a pair of MOS transistors connected in a differential amplifier form, which have gates to which positive and negative reference signals having a differential phase difference therebetween are respectively input, and first, second, third and fourth frequency conversion parts each of which is connected to the reference signal input part and includes a pair of MOS transistors. Local oscillator signals having a differential phase difference therebetween are input to the gates of the MOS transistors of the first and second frequency conversion parts. Local oscillator signals, which have phases orthogonal to phases of the local oscillator signals input to the first and second frequency conversion parts, are input to the gates of the MOS transistors of the third and fourth frequency conversion parts.

### BACKGROUND OF THE INVENTION

This application claims the priority of Korean Patent Application No. 2003-96891, filed on Dec. 24, 2003, in the Korean Intellectual Property Office, the disclosure of which is incorporated herein in its entirety by reference.

1. Field of the Invention The present invention relates to a frequency converter and, more particularly, to a frequency converter that can remove a DC offset and a second order intermodulation distortion component.

2. Description of the Related Art A heterodyne architecture in a transmitting/receiving circuit on a wireless channel requires a plurality of separate components including a surface acoustic wave filter. Thus, it is difficult to produce a compact transceiver and reduce its consumption power.

A direct conversion receiver directly converts a received reference signal to a baseband signal without converting it to an intermediate frequency so the receiver can be integrated into one chip. However, in the direct conversion receiver, a local oscillator signal used for down conversion has a magnitude considerably larger than that of a received reference signal. Thus, it is difficult for the frequency converter in the direct conversion receiver to control the generation of DC offset caused by local oscillator signal self-mixing.

A DC offset is generated by the leakage of the local oscillator signal to the input of the frequency converter, which is mixed then with local oscillator signal and a DC offset is generated. The local oscillator signal can leak directly to the input port of the frequency converter, of in-directly by capacitive coupling, coupling through substrate and inductive coupling. The local oscillator signal can be leak through LNA because of finite reverse isolation of the LNA. The local oscillator leakage signal is amplified by the LNA and mixed with local oscillator signal. The DC offset saturates an automatic gain control (AGC) or a low pass filter, which is connected to the back end of the frequency converter, to cause a signal distortion and deteriorate the sensitivity of a receiver.

Furthermore, the frequency converter in the direct conversion receiver brings about second order intermodulation distortion. The second order intermodulation distortion is close proximity to a signal converted by the frequency converter. When an interference signal having a relatively large magnitude is input to the frequency converter, the magnitude of an output second order intermodulation distortion component is larger than that of a desired output signal component to result in a reduction in receiving sensitivity.

Accordingly, studies on the direct conversion in order to remove the DC offset and second order intermodulation distortion component have been performed. An even harmonic mixer with a local oscillation signal frequency which is one-half of the reference signal containing RF signal frequency is a representative direct conversion technique.

FIG. 1 shows the configuration of a conventional even harmonic mixer. Referring to FIG. 1, the even harmonic mixer includes a band pass filter 10, a band rejection filter 20, and an anti-parallel diode 30. Specifically, the band pass filter 10 that amplifiers an input signal and a band rejection filter 20 that filters a noise of the input signal are located between an input signal port fi and an output signal port fo. The anti-parallel diode 30 is connected between the band pass filter 10 and band rejection filter 20. The anti-parallel diode 30 includes first and second diodes 31 and 32 connected to each other. One end of the anti-parallel diode 30 is connected to an open circuit stub 40 and the other end is connected to a short circuit stub 50.

The anti-parallel diode 30 has odd symmetrical characteristic and restricts an even-order distortion including self-mixing of a local oscillator signal LO according to the odd symmetrical characteristic. However, the magnitude of the local oscillator signal LO applied to control turning on/off of the diodes 31 and 32 is as large as more than 0 dBm so that it may produce a lot of leakage components in the even harmonic mixer.

To prevent the generation of the leakage components, another even harmonic mixer using transistors having a low DC offset has been proposed. FIG. 2 shows the even harmonic mixer using the transistors. Referring to FIG. 2, the even harmonic mixer includes first and second circuits 60 and 70. The first circuit 60 is constructed in a manner that a plurality of MOS transistors is connected in a differential amplifier form. Specifically, the first circuit 60 includes two sub differential circuits each of which has two MOS transistors connected in a differential amplifier form. Positive and negative local oscillating signal LO+ and LO−are respectively input to input ports of the MOS transistors constructing the sub differential circuits. The drains of the MOS transistors of each sub differential circuit are connected to each other. The first circuit 60 is connected to the second circuit 70 having MOS transistors connected in a differential amplifier form. Reference signals RF+ and RF− are applied to the MOS transistors of the second circuit 70.

The even harmonic mixer outputs a mixed signal of an odd-order harmonics of the reference signal RF and an even-order harmonics of the local oscillator signal LO. That is, the even harmonic mixer can prevent the reference signal RF from being mixed with an odd-order harmonics of the local oscillator signal LO. When the reference signal RF and local oscillator signal LO are sin ω_{RF}t and sin ω_{LO}t respectively, an output voltage V_{BB}(t) is represented as follows

$$\begin{matrix}{V}_{BB} ( t ) = {V}_{1} ( t ) - {V}_{2} ( t ) \\ = ( 4 {α}_{1} + 9 {α}_{3} + 35 {α}_{5} ) sin {ω}_{RF} t - \\ ( 3 {α}_{2} - 5 / 4 {α}_{5} ) sin 3 {ω}_{RF} t + 5 / 4 sin 5 {ω}_{RF} t - \\ ( 3 {α}_{3} + 5 {α}_{5} ) sin ( {ω}_{RF} \pm 2 {ω}_{LO} ) t + \\ 5 / 4 {α}_{5} sin ( {ω}_{RF} \pm 4 {ω}_{LO} ) t + \\ 5 / 2 {α}_{5} sin ( 3 {ω}_{RF} \pm 2 {ω}_{LO} ) t + …\end{matrix} \qquad [ Equation 1 ]$$

FIG. 3 shows the output spectrum of the even harmonic mixer, represented by Equation 1. Referring to Equation 1 and FIG. 3, the reference signal RF is downconverted by the second-order harmonic of the local oscillator signal LO to desired output signal ω_{RF}−2ω_{LO} and mirror signal ω_{RF}+2ω_{LO}. And, the odd-order harmonics of the reference signal RF, ω_{RF} and 3ω_{RF}, and mixed by even-order harmonics of the local oscillator signal LO, ω_{RF}±4ω_{LO} and 3ω_{RF}±2ω_{LO}, appear in the output signal of the even harmonic mixer of FIG. 2. Therefore, the even harmonic mixer has high spurious response levels including even-order harmonics of the LO signal.

The output voltage V_{BB}(t) when two closely spaced input tones ωₐ and ω_{b} are input to the reference signal RF ports of the even harmonic mixer is represented as follows.

$$\begin{matrix}{V}_{BB} ( t ) = {β}_{1} ( sin {ω}_{a} + sin {ω}_{b} ) t + \\ {β}_{2} \{ ( sin 2 {ω}_{a} + {ω}_{b} ) t + ( sin 2 {ω}_{b} - {ω}_{a} ) t \} + \\ {β}_{3} sin 2 {ω}_{LO} t sin ( {ω}_{a} - {ω}_{b} ) t + \\ {β}_{4} sin 2 {ω}_{LO} t sin ( 2 {ω}_{a} - {ω}_{b} ) t + \\ {β}_{5} sin 2 {ω}_{LO} t sin ( 2 {ω}_{b} - {ω}_{a} ) t + …\end{matrix} \qquad [ Equation 2 ]$$

From Equation 2, it can be known that third-order intermodulation distortion products 2ωₐ−ω_{b}−ω_{LO} and 2ω_{b}−ωₐ−ω_{LO} related with circuit linearity are exist in the output signal while second-order intermodulation distortion products ωₐ−ω_{b} and ω_{b}−ωₐ are suppressed. Therefore, this mixer has low third-order intercept point.

### SUMMARY OF THE INVENTION

The present invention provides a frequency converter that can remove a DC offset and suppress spurious responses and intermodulation distortion products.

According to an aspect of the present invention, there is provided a frequency converter that receives a reference signal and a local oscillator signal and outputs a frequency component corresponding to the sum or difference of a fundamental frequency of the reference signal and a second-order harmonic of the local oscillation signal. The frequency converter includes a reference signal input part including a pair of MOS transistors connected in a differential amplifier form, which have gates to which positive and negative reference signals having a differential phase difference therebetween are respectively input, and first, second, third and fourth frequency conversion parts each of which is connected to the reference signal input part and includes a pair of MOS transistors. Local oscillator signals having a differential phase difference therebetween are input to the gates of the MOS transistors of the first and second frequency conversion parts. Local oscillator signals, which have phases orthogonal to phases of the local oscillator signals input to the first and second frequency conversion parts, are input to the gates of the MOS transistors of the third and fourth frequency conversion parts.

The sources of the MOS transistors of the first and third frequency conversion parts are commonly connected to the drain of the MOS transistor of the reference signal input part, to which the positive reference signal is applied. The sources of the MOS transistors of the second and fourth frequency conversion parts are commonly connected to the drain of the MOS transistor of the reference signal input part, to which the negative reference signal is applied.

The drains of the MOS transistors of the first and fourth frequency conversion parts are commonly connected to a first output port BB⁻, and the drains of the MOS transistors of the second and third frequency conversion parts are commonly connected to a second output port BB⁺.

According to another aspect of the present invention, there is provided a frequency converter that receives a reference signal and a local oscillator signal and outputs a frequency component corresponding to the sum or difference of the reference signal and the even-order harmonics of the local oscillator signal. The frequency converter includes a reference signal input part including a pair of bipolar transistors connected in a differential amplifier form, which have bases to which positive and negative reference signals having a differential phase difference therebetween are respectively input, and first, second, third and fourth frequency conversion parts each of which is connected to the reference signal input part and includes a pair of bipolar transistors connected in a differential amplifier form. Local oscillator signals having a differential phase difference therebetween are input to the bases of the bipolar transistors of the first and second frequency conversion parts. Local oscillator signals, which have phases orthogonal to phases of the local oscillator signals input to the first and second frequency conversion parts, are input to the bases of the bipolar transistors of the third and fourth frequency conversion parts.

### BRIEF DESCRIPTION OF THE DRAWINGS

The above and other features and advantages of the present invention will become more apparent by describing in detail exemplary embodiments thereof with reference to the attached drawings in which:

FIG. 1 shows the configuration of a conventional even harmonic mixer employing diodes;

FIG. 2 is a circuit diagram of a conventional even harmonic mixer employing transistors;

FIG. 3 shows output spectrum characteristic of the even harmonic mixer of FIG. 1 and FIG. 2;

FIG. 4 is a circuit diagram of a frequency converter according to an embodiment of the present invention;

FIG. 5 shows the output spectrum of an even harmonic mixer according to an embodiment of the present invention; and

FIG. 6 is a circuit diagram of a frequency converter according to another embodiment of the present invention.

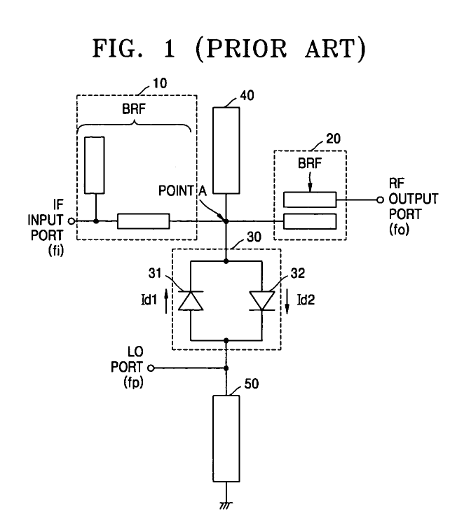

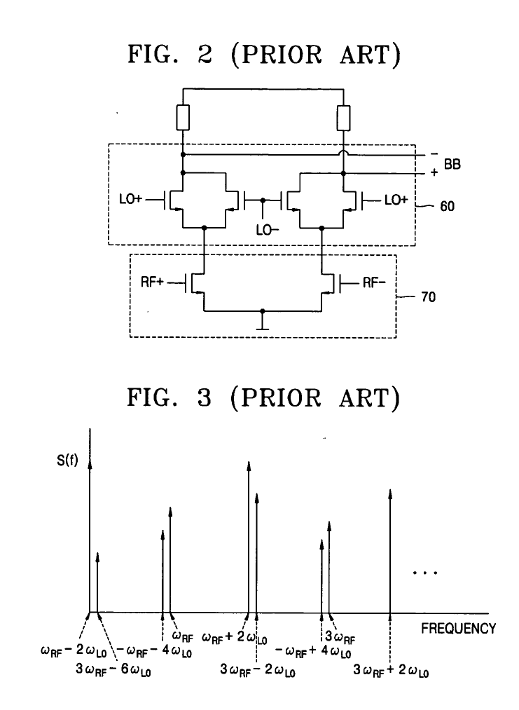

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

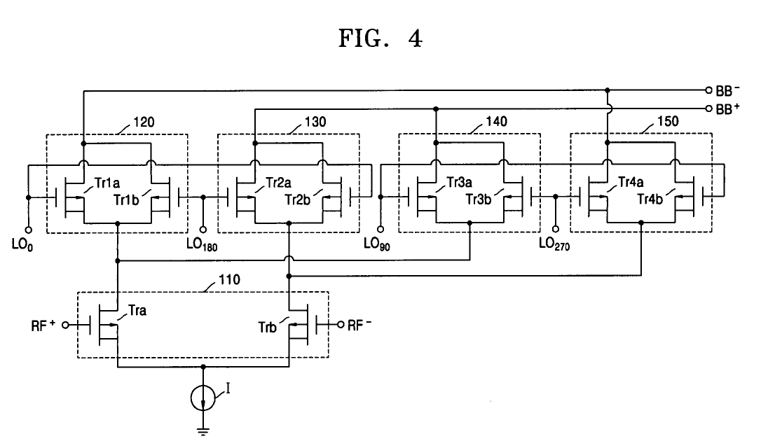

FIG. 4 is a circuit diagram of a frequency converter according to an embodiment of the present invention. Referring to FIG. 4, the frequency converter includes a reference signal input part 110, first, second, third and fourth frequency conversion parts 120, 130, 140 and 150.

The reference signal input part 110 includes a pair of first and second MOS transistors Tra and Trb connected in a differential amplifier form. Reference signals RF+ and RF− having a differential phase difference therebetween are input to the gates of the first and second MOS transistors Tra and Trb. The sources of the MOS transistors Tra and Trb are coupled to each other and connected to a current source I.

The first frequency conversion part 120 is connected to the drain of the first MOS transistor Tra of the reference signal input part 110. The first frequency conversion part 120 includes a pair of first and second MOS transistors Tr1a and Tr1b connected in a differential amplifier form. A local oscillator signal LO₀ is input to the gate of the first MOS transistor Tr1a of the first frequency conversion part 120 and a local oscillator signal LO₁₈₀ having a differential phase difference from the local oscillator signal LO₀ is input to the gate of the second MOS transistor Tr1b. The sources of the first and second MOS transistors Tr1a and Tr1b of the first frequency conversion part 120 are coupled to each other and connected to the reference signal input part 110. The drains of the first and second MOS transistors Tr1a and Tr1b are connected to a first output port BB⁻.

The second frequency conversion part 130 is connected to the drain of the second MOS transistor Trb of the reference signal input part 110. The second frequency conversion part 130 includes a pair of first and second MOS transistors Tr2a and Tr2b connected in a differential amplifier form. The local oscillator signal LO₁₈₀ is input to the gate of the first MOS transistor Tr2a of the second frequency conversion part 130 and the local oscillator signal LO₀ having a differential phase difference from the signal LO₁₈₀ is input to the gate of the second MOS transistor Tr2b. The sources of the first and second MOS transistors Tr2a and Tr2b of the second frequency conversion part 130 are coupled to each other and connected to the reference signal input part 110. The drains of the first and second MOS transistors Tr2a and Tr2b are connected to a second output port BB^{±}.

The third frequency conversion part 140 is connected to the drain of the first MOS transistor Tra of the reference signal input part 110. The third frequency conversion part 140 includes a pair of first and second MOS transistors Tr3a and Tr3b connected in a differential amplifier form. A local oscillating signal LO₉₀ is input to the gate of the first MOS transistor Tr3a of the third frequency conversion part 140 and the local oscillator signal LO₂₇₀ having a differential phase difference from the signal LO₉₀ is input to the gate of the second MOS transistor Tr3b. The sources of the first and second MOS transistors Tr3a and Tr3b of the third frequency conversion part 140 are coupled to each other and connected to the reference signal input part 110. The drains of the first and second MOS transistors Tr3a and Tr3b are connected to the second output port BB⁺.

The fourth frequency conversion part 150 is connected to the drain of the second MOS transistor Trb of the reference signal input part 110. The fourth frequency conversion part 150 includes a pair of first and second MOS transistors Tr4a and Tr4b connected in a differential amplifier form. The local oscillator signal LO₂₇₀ is input to the gate of the first MOS transistor Tr4a of the fourth frequency conversion part 150 and the local oscillator signal LO₉₀ having a differential phase difference from the local oscillator signal LO₂₇₀ is input to the gate of the second MOS transistor Tr4b. The sources of the first and second MOS transistors Tr4a and Tr4b of the fourth frequency conversion part 150 are coupled to each other and connected to the reference signal input part 110. The drains of the first and second MOS transistors Tr4a and Tr4b are connected to the first output port BB⁻. That is, the drain of the first frequency conversion part 120 is connected to the drain of the fourth frequency conversion part 140, and the drain of the second frequency conversion part 130 is connected to the drain of the third frequency conversion part 140.

Each of the first, second, third and fourth frequency conversion parts 120, 130, 140 and 150 outputs the sum of the reference signal RF and local oscillator signal LO or the difference between the two signals through the first or second output port BB⁻ or BB⁺. Here, LO₉₀, LO₂₇₀, LO₀, LO₁₈₀ represent phases of the local oscillator signal.

The operation of the frequency converter having the aforementioned configuration is explained below.

The frequency converter of the present invention can restrain second order intermodulation distortion components through the reference signal input part 110.

The reference signal input part 110 is parallel with the first and second frequency conversion parts 120 and 130 to which differential phases LO₀ and LO₁₈₀ are input. The reference signal input part 110 is parallel with the third and fourth frequency conversion parts 140 and 150 to which differential phases LO₉₀ and LO₂₇₀ are input. When the drains of all the MOS transistors of the first, second, third and fourth frequency conversion parts 120, 130, 140 and 150 are connected, each frequency conversion part has odd symmetrical characteristic. Accordingly, each frequency conversion part restrains the intermodulation distortion products with even-order harmonics of the local oscillator signal LO including self-mixing of the local oscillator signal LO. When the drains of the MOS transistors of the first and fourth frequency conversion parts 120 and 150, which have an orthogonal phase difference for the local oscillator signal LO, are connected with each other and the drains of the MOS transistors of the second and third frequency conversion parts 130 and 140, which have an orthogonal phase difference for the local oscillator signal LO, are connected with each other, the output ports BB+ and BB− of the frequency conversion parts 120, 130, 140 and 150 can suppress the spurious response with a quadruple-order local oscillator signal component and a signal having a first-order harmonic of the reference signal RF and a first-order harmonic of the local oscillator signal LO.

When the reference signal RF is sin ω_{RF}t and the local oscillator signal LO is sin ω_{LO}t, the output voltage V_{BB}(t) is represented as follows.
V_{BB}(t)=(3α₅+5α₅)sin(ω_{RF}−2ω_{LO})t−(3α₃+5α₅)sin(ω_{RF}+2ω_{LO})t [Equation 3]

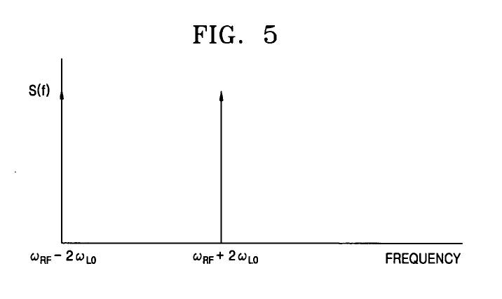

FIG. 5 shows the output spectrum of the even harmonic mixer according to the present invention. Referring to Equation 3 and FIG. 5, all of the spurious signals except for a desired signal and a mirror signal are not appear in the output of the even harmonic mixer of the invention.

When two closely spaced input tones ωₐ and ω_{b} are input to the RF ports of the reference signal input part, the output voltage V_{BB}(t) is represented as follows.
V_{BB}(t)=α₃ {sin(2ω_{α}+ω_{LO})t+sin(2ω_{α}+ω_{LO})t+sin(2ω_{b}−ω_{LO})t+sin(2ω_{b}+ω_{LO})t} [Equation 4]

It can be known from Equation 4 that the even harmonic mixer of the invention does not all of the intermodulation distortion products include third order intermodulation distortion product and second order intermodulation distortion product. Accordingly, the even harmonic mixer having excellent linearity can be obtained.

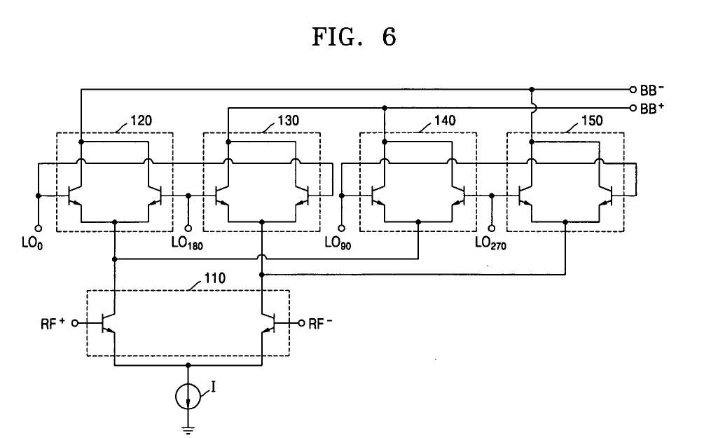

While the frequency conversion parts and reference signal input part include the MOS transistors in the above-described embodiment, bipolar transistors can replace the MOS transistors as shown in FIG. 6.

As described above, the even harmonic mixer according to the present invention can remove a DC offset due to self-mixing of a local oscillator signal and second order intermodulation distortion components. Furthermore, while the conventional even harmonic mixer uses only the differential phase of the local oscillator signal, the even harmonic mixer of the invention uses the orthogonal phase difference of the local oscillator signal in addition to the differential phase difference. Thus, the even harmonic mixer of the invention can remove unnecessary output spurious response and intermodulation distortion products so as to obtain excellent output spectrum characteristic and linearity.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A frequency converter that receives a reference signal and a local oscillator signal and outputs a frequency component corresponding to the sum or difference of the reference signal and the even-order harmonics of local oscillator signal, comprising:
a reference signal input part including a pair of MOS transistors connected in a differential amplifier form, which have gates to which positive and negative reference signals having a differential phase difference therebetween are respectively input; and
first, second, third and fourth frequency conversion parts each of which is connected to the reference signal input part and includes a pair of MOS transistors,
wherein local oscillator signals having a differential phase difference therebetween are input to the gates of the MOS transistors of the first and second frequency conversion parts, and local oscillator signals, which have phases orthogonal to phases of the local oscillator signals input to the first and second frequency conversion parts, are input to the gates of the MOS transistors of the third and fourth frequency conversion parts.

2. The frequency converter as claimed in claim 1, wherein the sources of the MOS transistors of the first and third frequency conversion parts are commonly connected to the drain of the MOS transistor of the reference signal input part, to which the positive reference signal is applied.

3. The frequency converter as claimed in claim 1, wherein the sources of the MOS transistors of the second and fourth frequency conversion parts are commonly connected to the drain of the MOS transistor of the reference signal input part, to which the negative reference signal is applied.

4. The frequency converter as claimed in claim 1, wherein the drains of the MOS transistors of the first and fourth frequency conversion parts are commonly connected to a first output port, and the drains of the MOS transistors of the second and third frequency conversion parts are commonly connected to a second output port

5. A frequency converter that receives a reference signal and a local oscillator signal and outputs a frequency component corresponding to the sum of the reference signal and the even-order frequency components of local oscillator signal or the difference of the reference signal and the even-order frequency components of local oscillator signal, comprising:
a reference signal input part including a pair of bipolar transistors connected in a differential amplifier form, which have bases to which positive and negative reference signals having a differential phase difference therebetween are respectively input; and
first, second, third and fourth frequency conversion parts each of which is connected to the reference signal input part and includes a pair of bipolar transistors connected in a differential amplifier form,
wherein local oscillator signals having a differential phase difference therebetween are input to the bases of the bipolar transistors of the first and second frequency conversion parts, and local oscillator signals, which have phases orthogonal to phases of the local oscillator signals input to the first and second frequency conversion parts, are input to the bases of the bipolar transistors of the third and fourth frequency conversion parts.
